(19) United States
(12) Patent Application Publication
(10) Pub. No.: US 2011/0233441 A1
(43) Pub. Date: Sep. 29, 2011

(54) LINEAR ACTUATOR WITH INTERNAL LINEAR TO ROTARY CONVERSION AND EXTERNAL ROTARY COMPONENT

(76) Inventor: Allan Graeme Miners, New South Wales (AU)

(21) Appl. No.: 13/132,030

(22) PCT Filed: Nov. 2, 2009
(86) PCT No.: PCT/AU2009/001424

§ 371 Date: May 31, 2011

(30) Foreign Application Priority Data
Dec. 16, 2008 (AU) 2008906434

(51) Int. Cl. F16K 1/00; F16K 7/00

(52) U.S. Cl. 251/324; 251/331

(57) ABSTRACT

An actuator including a barrel, two end caps, a piston, a guide slot, a hollow shaft and a twisted bar connected to an external rotating hub whereby any linear movement of the actuator shaft produces proportionate rotation of the external hub either clockwise or anti-clockwise direction, dependent on the direction of the linear travel of the actuator shaft.

### THE NEED

In industrial processes valves are used in order to vary plant conditions ie to close off a flow in a pipe completely, perhaps open it to allow full flow, or vary the flow on demand. These valves can be operated manually by a local operator but when the valves need to be operated from a control system they are fitted with actuators which are generally pneumatic, hydraulic, or electrically powered and receive signals from a remote controller to open or shut the valve depending on process requirements. In order to control the system the actuators are fitted with control accessories such as:

Switch boxes: To send signals to the controller advising when the valve is shut or open

Positioners: These devices receive signals from the controller and can position the actuator in any position between open or shut to control process variables such as the flow through the pipeline:

Local indicators: are mounted on top of the actuators and provide local visual indication of the valve position

One thing these accessories have in common is that they are designed specifically for rotary actuators. and use an industry standard mounting pattern.

### Why?

By far the vast proportion of valves utilized in todays processes are rotary in design. That is the valve operates in a rotary motion and almost without exception, rotates from 0 degrees through to 90 degrees from open to closed or vice versa. Consequently the manufacturers of actuator control accessories design them for rotary actuators and all manufacturers today make to a common standard of mounting pattern to allow different manufacturers devices to be used on other manufacturers actuators. The mounting dimensions depicted in drawing 1A page 12 are the most common

Drawing 1A shows the standard dimensions of the actuator and the accessories, regardless of the function of the accessory they will in the main adhere to this common mounting pattern. The accessory having a male tang approximately 3.9 mm wide and the actuator having a drive shaft protruding from the body 19 to 20 mm high and female slot 4 mm wide to accept this male tang

Drawing 1B page 13 shows the simplicity of matching the two rotary devices pictured in drawing 1A. Even the mounting bracket which joins the two is a standard off the shelf item

Reason for the invention is the problem with linear actuators and accessories

Whilst the vast majority of valves are rotary and are well provided for by way of actuators, accessories and ease of mounting, there are still a large number of valves that are linear by design, and in order to open or shut the valve remotely the valve must be fitted with a linear actuator. There are no standard accessory devices for these actuators and the general rule is that standard rotary accessories are used and a linear to rotary conversion mechanism must be used to convert the linear movement to an equivalent rotary action so that a rotary accessory may be used.

A conventional linear cylinder used for these linear valves is shown in Drawing 2A page 14

Drawing 2A depicts a conventional linear pneumatic/hydraulic power cylinder/actuator consisting of a barrel two end caps a piston and a solid drive shaft. This type of actuator is commonly used to drive linear valves in process control systems.

### Actuator Movement:

Whenever air or other pressurized medium is introduce into chamber P1 or P2 and there is a pressure difference, or imbalance between the two chambers the piston will move the drive shaft to the left or the right depending apon which chamber is at the highest pressure.

The actuator is connected to a valve and plant control systems vary the pressure which is applied to chambers P1 and P2 to control the position of the valve.

As with rotary actuators, In order to control the valve accessories must be mounted to the actuator to receive control signals, or transmit the position of the shaft in order that the control system can vary the control pressures to the actuator in accordance with process requirements. Standard rotary accessories can be used but a mechanism to convert the linear movement to rotary is mounted externally on the side of the actuator to achieve this as shown in drawing 2B page 15

### FUNCTION

Drawing 2B depicts a standard Rotary positioner mounted to the side of a conventional cylinder operating a knife gate valve, this is the most common arrangement used today

Any linear movement of the cylinder shaft forces the shaft connecting rod (A) to move in the same direction. Connecting rod (A) is joined with a fixed pivot to connecting rod (B) and whereas connecting rod (B) is connected to the slotted extension arm (E) by a sliding pin (d) the linear travel is transmitted to the positioner as a rotary movement in proportion to the linear movement of the actuator shaft.

Calibration is achieved by altering the length of the shaft connecting rod (B) for the zero position and moving the position of the sliding pin (D) in the slotted extension arm (D) for span (travel). Note the drawing shows a positioner however the same could be a standard limit switch box, Position indicator, Retransmission module etc

### Negatives

1) There is no standard arrangement for this, the assembly has to be custom made to match each cylinder and accessory combination this is time consuming and expensive

2) The fact that the assembly is external makes it susceptible to damage

3) With two pivot points accuracy is difficult to maintain

### THE INVENTION

### Drawing 3A Page 16 is my Design.

Unlike the conventional cylinder actuator depicted in drawing 2A the drive shaft (1) is hollow which can accommodate the twisted connection bar (2). A guide slot is machined into the piston bolt (3) and contains four bearings through which the twisted bar travels, the bearings are set to allow the bar to move freely through the guide slot but with a minimum of clearance. As the guide slot remains in a constant fixed plane and the connection bar is twisted, the bar rotates proportionate to the Piston and shaft travel, and as the bar is fixed to the external rotating hub this also rotates in proportion to the length of travel. The rotating hub is sealed With an o-ring to prevent leakage of the internal air pressure to atmosphere. and a thrust bearing is fitted to reduce friction.

The twisted bar can be set to translate any given linear travel of the drive shaft to a desired proportional rotary movement in the external rotating hub. In 95% cases this rotation will be 0 to 90 degrees for full travel of the cylinder/valve as this is the industry standard for rotary devices.

Drawing 3B page 17 shows the differences between a conventional cylinder and my design. The inclusion of a hollow shaft, twisted bar, guide slot and external rotating hub can be seen

Drawing 4A page 18 shows the invention with a standard rotary positioner mounted. As the linear to rotary conversion is done internally. A standard rotary positioner or switch box bolts directly on to the top of the actuator exactly as it would to a standard rotary actuator as shown in drawing 1B with no need for additional arms, levers and pivots as required by the conventional cylinder as shown in drawing 2B page 15

### Advantages

1) The cylinder uses standard off the shelf components and mounting brackets regardless of the size of the cylinder or manufacturer of the accessory
2) Greater accuracy with only one connection point between the valve and actuator (the twisted bar through the guide slot) as distinct from two in the current system
3) Fitting and calibration is quicker and easier
4) The final assembly as is more compact and as the linear to rotary conversion is done internally it is less susceptible to damage
5) The cost is far less

### Drawing 5A Page 19

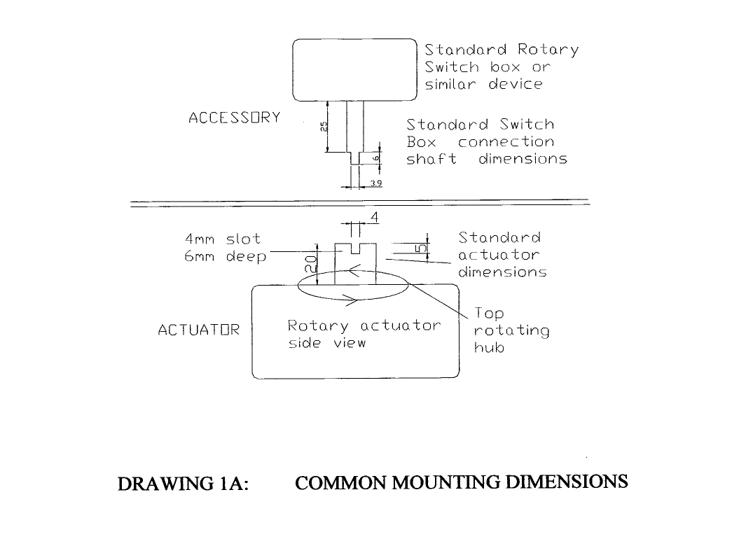

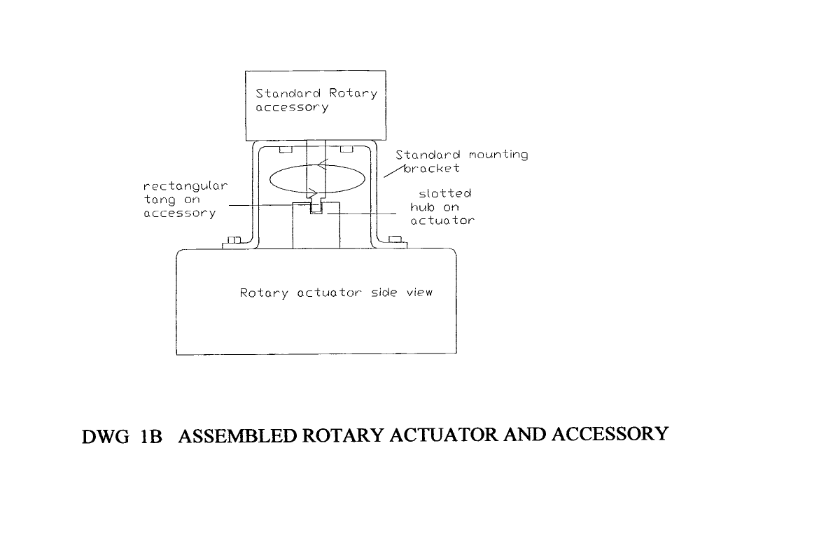

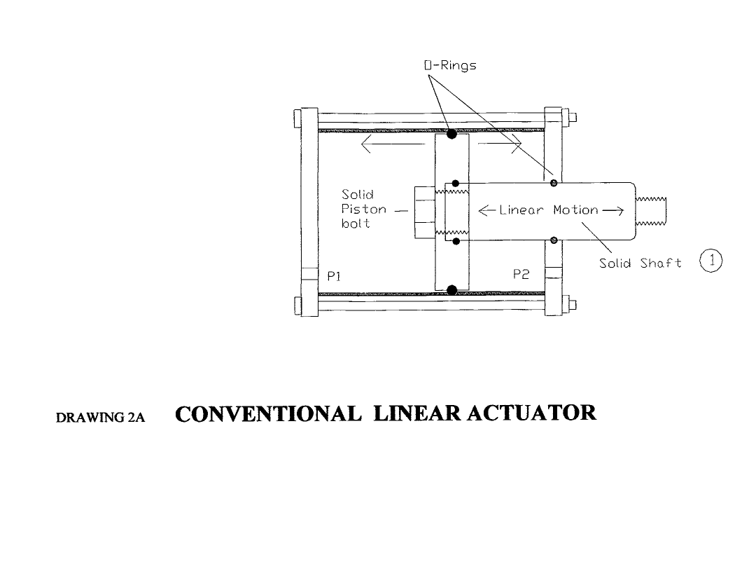

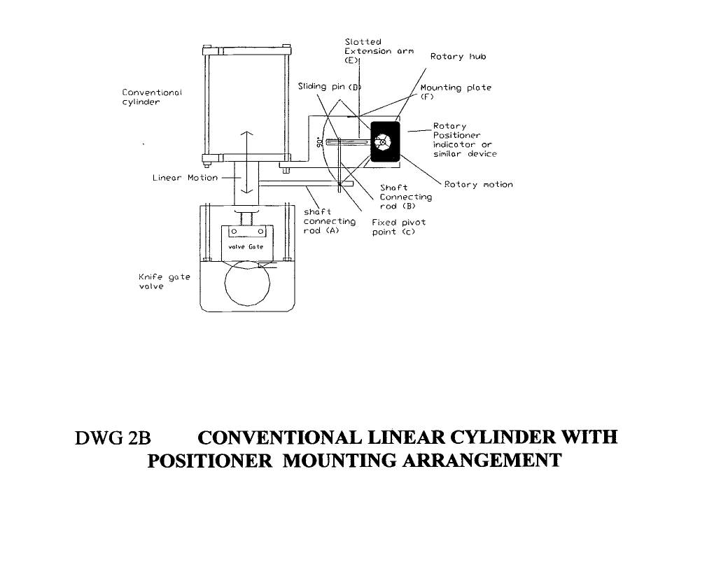

FIG. 1 shows a conventional cylinder mounted to a knife gate valve and fitted with a positioner

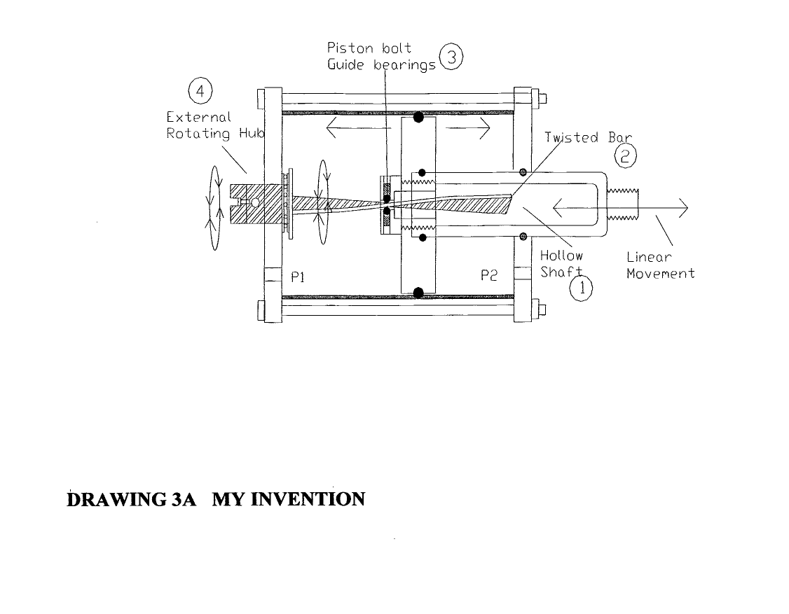

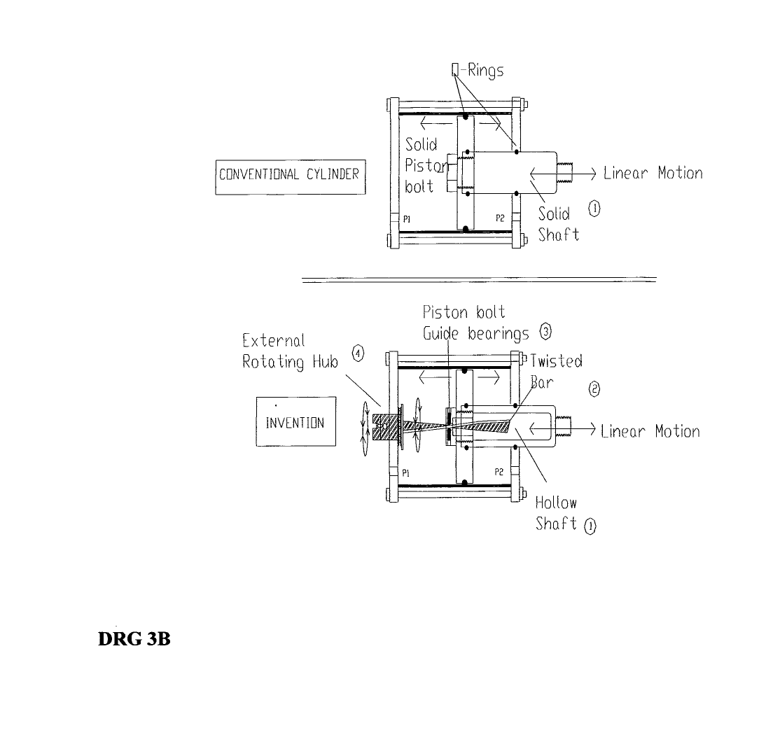

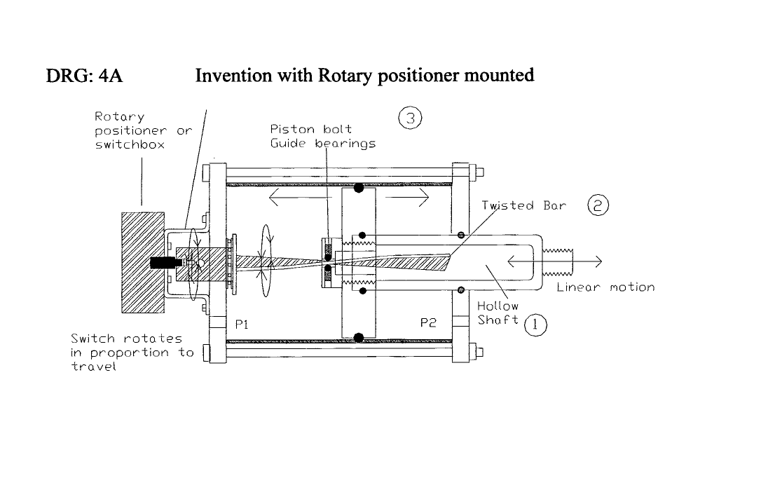

FIG. 2 Is an identical valve and positioner but mounted to the invention, the valve assembly is identical to FIG. 1, the positioner however attaches to the invention with just a standard bracket and four screws, as used in a standard rotary actuator assembly as shown in drawing 1B

### Calibration

Field calibration is quick and simple

### DRAWING 6A Page 20

FIG. 1

Shows the cylinder mounted to a knife gate valve assembled with the UNTWISTED CONNECTION BAR penetrating through the guide slot and the accessory slot in the external hub in the closed position. In this state if the piston and shaft move in either direction there is no rotation of the connection bar and external hub due to the fact that as the bar is not twisted there are no axial forces being applied from the guide slot as the shaft moves

FIG. 2

With the valve Still in the closed position, a rod is inserted into the rod hole in the external rotating hub and turned until the accessory slot is in the desired plane generally 90 degrees. As the connection bar is anchored by the guide slot which is now at the bottom of the cylinder, the action of turning the external hub twists the bar to the desired degree of twist.

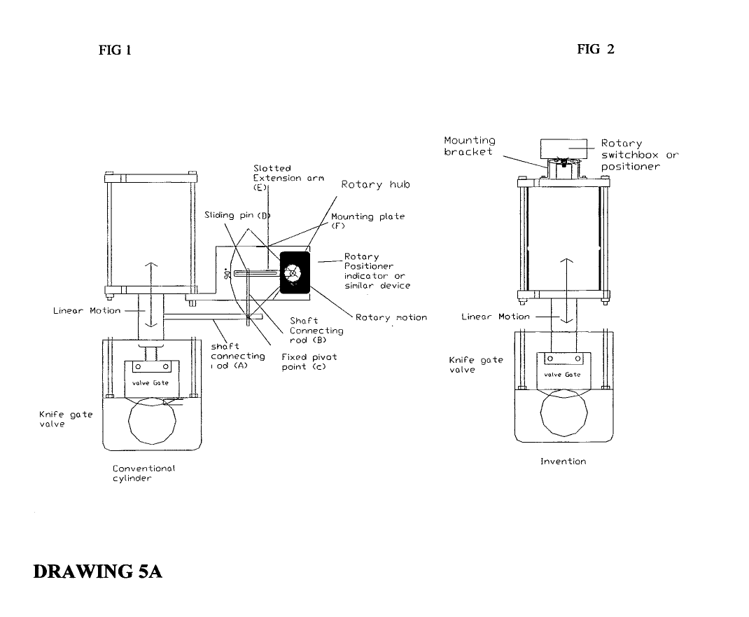

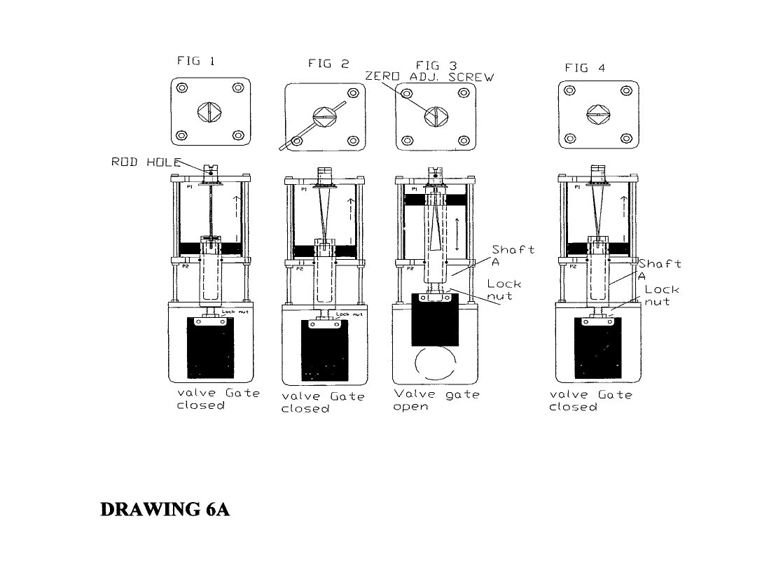

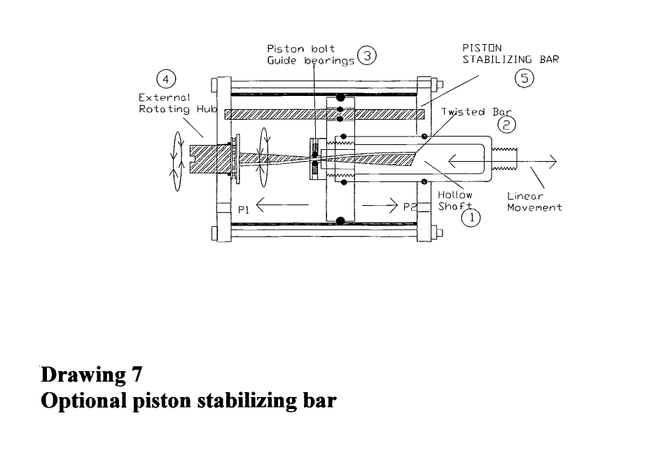

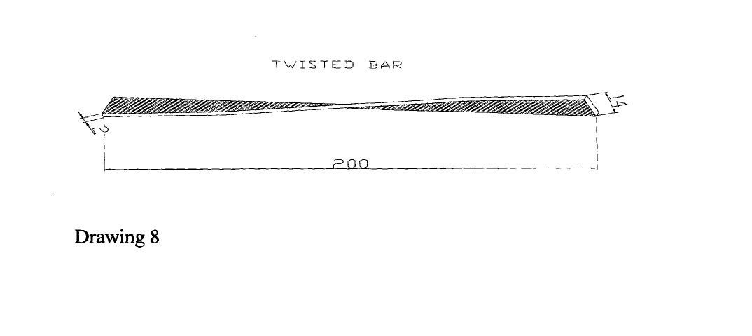

FIG. 3

When the valve is opened and the piston returns to top of the cylinder the forces acting on the now twisted connection bar as it moves through the guide slot, rotate the external hub back to a near vertical or “zero position” The zero position can now adjusted

### Note:

As in all calibration procedures there is a ZERO and a SPAN adjustment Span is achieved by varying the amount of twist applied to the connection bar whilst the ZERO position is set by loosening the zero adjustment screw which allows the slot to rotate independently from the rotating hub, turning the slot to achieve the desired zero position and then re-tightening the zero adjustment screw

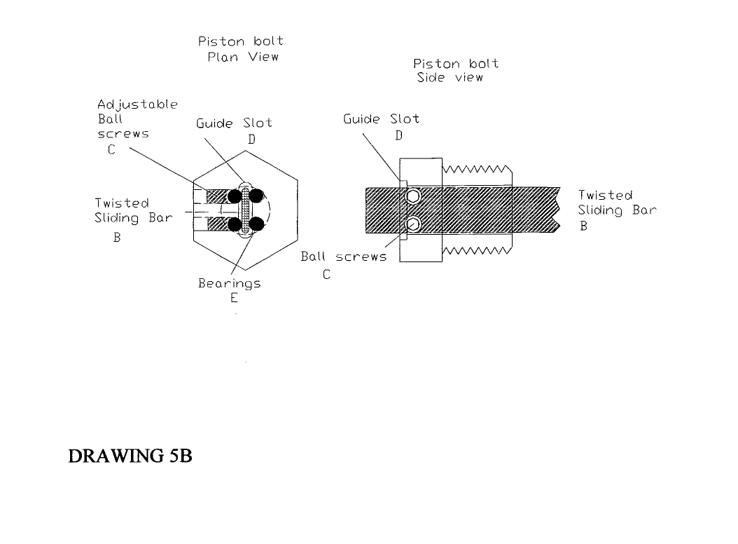

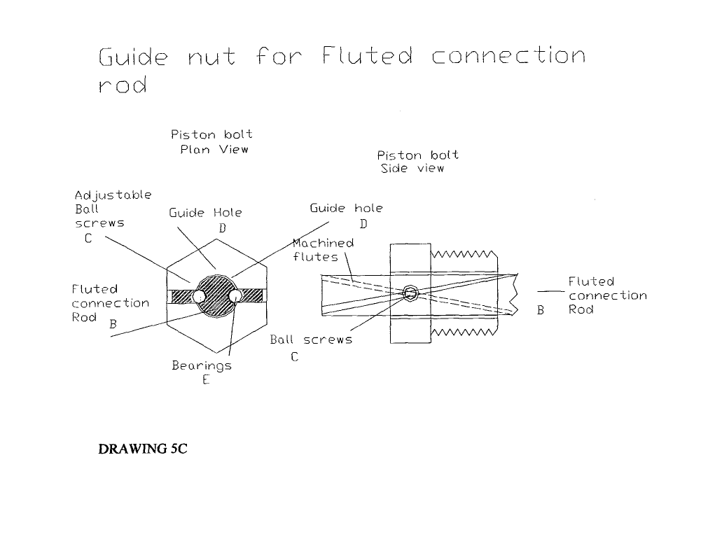

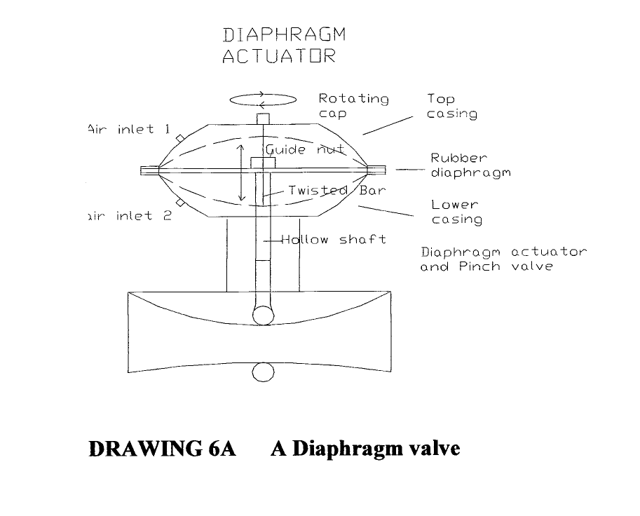

FIG. 4

When the valve is returned to the closed position the slot on the external hub returns to the closed position

From hereon when the valve is opened or closed the external hub rotates accordingly drawing shows a plan view and shows two bearings are fixed and two can be adjusted to provide optimum clearance

Once set the adjustable screws are loctited in position The drawing on the right illustrates the same setup from a side view. This can be made from any steel or suitable composite material

### Alternative Design Using Machined Fluted Connection Rod

### 5C Page 24

By utilizing a twisted bar in the design the unit is, low cost and able to be calibrated in the field after assembly to the valve. This system is simple, accurate and ideal in 90% of applications however the degree of twist is always linear with respect to shaft travel and cannot be characterized.

In those instances where the degree of rotation of the external hub vs length of travel needs to be characterized, a round connection bar is used and flutes are machined, or cast on the external surface to provide any degree of rotation desired at any point in the travel of the shaft. In this case the guide nut utilises bearings which engage the flutes as shown as shown in drawing if this principal is employed the unit can not be field calibrated

The concept of a hollow shaft, guide slot and twisted bar can also be applied to a diaphragm actuator shown in DWG 6A page 25

As pressure is introduced into inlet 1 or two respectively the rubber diaphragm moves in one direction or another generating a linear movement of the shaft which is used to drive a valve

If the hollow shaft, twisted rod and guide slot are incorporated into this style of actuator all the same benefits are realised

### Optional Piston Stabilizing Bar

### Drawing 7 Page 21

In order that the zero point reman constant it is important that the piston does not rotate after calibration is performed

In 90% of applications the cylinder shaft is locked to the valve and thus the piston cannot move because it is secured to the shaft by the piston bolt and a stabilizing bar is not necessary. If however the shaft is not locked to a fixed point such as the valve, a piston stabilizing bar is fitted This bar is anchored at each end by the cylinder end caps and passes through the piston with an o-ring seal preventing leakage from one chamber to the other. This allows the system to function as normal whilst the piston is prevented from rotating

### Materials of Construction:

### The Twisted Connection Bar Drawing 8 Page 22

made from steel, hardened and then tempered to provide optimum hardness but still allow the bar to be twisted and maintain the desired degree of twist when released. Any alternative material which provides similar characteristics could be utilized. Actual dimensions are not critical but engineering tests confirm that a bar 12 to 14 mm wide is highly suitable for the application, with thickness varying from 1 mm for shorter strokes (shaft travel) below 100 mm up to 2 mm thick for longer strokes.

Bearings are standard chrome steel bearings, but alternative bearings of similar or higher hardness would suffice.

All other components are similar to those found in conventional cylinders

Note the guide slot does not need bearings for the invention to function providing it is made from a hardened material to prevent wear however the addition of the bearings extends the life of the unit immensely reducing wear to an absolute minimum.

The addition of a needle thrust bearing on the rotating hub is also included to minimise turning forces required and thus extend the life of the unit

### Piston Retaining Bolt

Drawing 5B page 23 shows the piston retaining bolt which which bolts the piston to the drive shaft and also houses the guide slot and bearings The first

1-5. (canceled)

6. An actuator with an elongate housing, a piston arranged for linear travel through the housing and a coupling for transmitting movement of the piston into corresponding mechanical output of the actuator, the actuator having an external connector at an end of the housing remote from the coupling, the connector being coupled to the piston so that linear movement of the piston causes rotation of the connector so as to indicate a position of the piston within the housing.

7. The actuator of claim 6, wherein the coupling is a piston rod, which projects externally of the housing.

8. The actuator as claimed in claim 6, wherein the connector includes a rotating hub with a radial slot to engage a shaft of an accessory unit.

9. The actuator as claimed in claim 8, wherein the slot is in the order of substantially 4 mm in width and substantially 6 mm in depth, to fit with standardised rotary accessories.

10. The actuator as claimed in claim 9, wherein the hub has a height dimension in the order of substantially 20 mm.

11. The actuator as claimed in claim 8, further including a bracket connected relative to the housing, the bracket having a mounting plate to which the accessory is secured and an opening through which the shaft of the unit passes to engage with the connector.

12. The actuator as claimed in claim 11, wherein the mounting plate sits over the connector and is spaced from the end of a housing by supporting legs which are mounted to the housing such that the opening aligns with the connector.

13. The actuator as claimed in claim 12, wherein the mounting plate includes preformed through holes, for receipt of fasteners which are used to attach the accessory unit to the bracket.

14. The actuator as claimed in claim 6, wherein the connector is coupled to a twisted bar which extends axially though the housing, the bar passing through a guide slot in the piston, whereby axial movement of the piston causes rotation of the bar, to thereby rotate the connector.

15. The actuator as claimed in claim 6, wherein the connector is coupled to a rod which extends axially through the housing, the rod passing through a guide slot in the piston which couples with flutes formed helically along the rod, whereby axial movement of the piston causes rotation of the rod, to thereby rotate the connector.

16. The actuator as claimed in claim 6, wherein an elongate stabilizing bar is fitted internally of the actuator to prevent the piston rotating as the piston travels through the housing.

17. The actuator as claimed in claim 1, in combination with an accessory unit in the form of a rotary switchbox, positioner or indicator, the unit having a shaft engaged with the connector of the actuator to provide input to the unit corresponding to the rotary position of the connector, which thereby indicates the linear position of the piston.

18. An actuator with an elongate housing, a diaphragm arranged for linear travel through the housing and a coupling for transmitting movement of the diaphragm into corresponding mechanical output of the actuator, the actuator having an external connector at an end of the housing remote from the coupling, the connector being coupled to the diaphragm so that linear movement of the diaphragm causes rotation of the connector so as to indicate a position of the diaphragm within the housing.
